(19) United States
(12) Patent Application Publication
(10) Pub. No.: US 2024/0106851 A1
(43) Pub. Date: Mar. 28, 2024

(54) SYSTEM AND METHOD FOR PERFORMING AN INFORMATION TECHNOLOGY SECURITY RISK ASSESSMENT

(71) Applicant: The Toronto-Dominion Bank, Toronto (CA)

(72) Inventors: Charles KENNEDY, Toronto (CA); Michel Maurice REMACLE, Toronto (CA)

(21) Appl. No.: 17/952,621

(22) Filed: Sep. 26, 2022

(51) Int. Cl. H04L 9/40; G06F 3/0482

(52) U.S. Cl. CPC H04L 63/1433; G06F 3/0482

(57) ABSTRACT

Computing platforms, methods, and storage media for performing an information technology security risk assessment are disclosed. Exemplary implementations may: provide a tool assessment interface for receiving model data associated with a software tool; obtain the model data for the software tool; perform a software tool risk assessment based on the model data and independent from the tool-specific functionality data; generate a model-based risk determination based on the software tool risk assessment; and output the model-based risk determination via the tool assessment interface. Exemplary implementations may use model data to perform a software tool risk assessment, rather than a model assessment, without requiring disclosure of confidential functionality details associated with the software tool, such as relating to artificial intelligence or machine learning. Exemplary implementations may pre-populate a first set of data in the interface and prompt a vendor to obtain a vendor-provided second set of model data via the interface.

### FIELD

The present disclosure relates to software risk assessment, including but not limited to computing platforms, methods, and storage media for performing an information technology security risk assessment.

### BACKGROUND

Organizations undertake IT security reviews and risk assessments, such as cyber risk assessments, when evaluating new IT or software tools to implement. Typically, a vendor of a software tool is required to provide technical details on specific functions the tool performs, and how the functions are performed by the tool.

In the case where the tool includes artificial intelligence (AI) and/or machine learning (ML), a vendor may be prohibited from disclosing details about the secret inside the “black box”. This causes complications with respect to IT security reviews, which rely on such details to perform an adequate risk assessment.

Improvements in approaches for performing an information technology security risk assessment are desirable.

### BRIEF DESCRIPTION OF THE DRAWINGS

Embodiments of the present disclosure will now be described, by way of example only, with reference to the attached Figures.

FIG. 1 illustrates a system configured for performing an information technology security risk assessment, in accordance with one or more embodiments.

FIG. 2 illustrates another system configured for performing an information technology security risk assessment, in accordance with one or more embodiments.

FIG. 3 illustrates a method for performing an information technology security risk assessment, in accordance with one or more embodiments.

FIG. 4 illustrates a method of initiating an information technology security risk assessment, in accordance with one or more embodiments.

FIGS. 5-10 illustrate examples of an interface generated in accordance with one or more embodiments as part of an information technology security risk assessment.

### DETAILED DESCRIPTION

Computing platforms, methods, and storage media for performing an information technology security risk assessment are disclosed. Exemplary implementations may: provide a tool assessment interface for receiving model data associated with a software tool; obtain the model data for the software tool; perform a software tool risk assessment based on the model data and independent from the tool-specific functionality data; generate a model-based risk determination based on the software tool risk assessment; and output the model-based risk determination via the tool assessment interface. Exemplary implementations may use model data to perform a software tool risk assessment, rather than a model assessment, without requiring disclosure of confidential functionality details associated with the software tool, such as relating to artificial intelligence or machine learning. Exemplary implementations may pre-populate a first set of data in the interface and prompt a vendor to obtain a vendor-provided second set of model data via the interface.

The present disclosure provides an anonymized model risk management process to perform, or assist in performing, IT security risk management.

In accordance with one or more embodiments, an anonymized user interface, which may be provided as a form or a document, may be created and provided to a vendor, to obtain missing information that an organization needs to perform a risk assessment, without the vendor needing to disclose confidential information, or even information identifying what the tool does. A process in accordance with one or more embodiments analyzes data associated with a model behind a tool, to help with risk management for the tool itself.

Embodiments of the present disclosure are most relevant in situations where a vendors will not, or cannot, provide an organization with proprietary or confidential details about the operation of the tool, such as when artificial intelligence (AI) and machine learning (ML) are involved. In the absence of being able to ask a vendor for specific details on how the AI or ML works within the software tool, embodiments of the present disclosure provide a means to perform a software tool risk assessment without needing that information that the vendor may not be in a position to disclose.

Embodiments of the present disclosure use an anonymized model risk management process to perform, or assist in performing, IT security risk management. The process is model agnostic, which is important. In an implementation, when a tool is identified as having certain functionality, the system may pre-populate specific sections of an interface based on the type of tool (e.g. bot detection, firewall, email malware, etc.). Pre-populating may include populating what would otherwise be a blank field, or a selector from which a selection is made from among a set of possible answers, with a default answer before the field or selection is provided via the interface. The selector may comprise a drop-down menu, a set of radio buttons, a set of checkboxes, or any other input selection means. In an example embodiment, the pre-population may comprise: identifying a question for which an answer may be pre-populated; obtaining pre-population data for the answer based on a tool type identifier; and presenting the interface with the question and the pre-populated answer. In an implementation, the system/method outputs the result and/or the anonymized interface output, which may be a document.

In cybersecurity, things change drastically and very quickly. Embodiments of the present disclosure provide an approach using an anonymized input that can be used to perform IT security risk management. The input may be anonymized in terms of not requiring tool-specific functionality data to be disclosed, and rather be based on model data characterizing the software tool. Applications include using model risk management for cyber tooling and cyber relevant capabilities, also related to infrastructure. Embodiments of the present disclosure also address the challenge of trying to extract information from a vendor, where the vendor does not want to, or contractually cannot, provide the information being requested.

One aspect of the present disclosure relates to a computing platform configured for performing an information technology security risk assessment. The computing platform may include a non-transient computer-readable storage medium having executable instructions embodied thereon. The computing platform may include one or more hardware processors configured to execute the instructions. The processor(s) may execute the instructions to provide a tool assessment interface for receiving model data associated with a software tool. The software tool may be characterized by the model data and by tool-specific functionality data. The processor(s) may execute the instructions to obtain the model data for the software tool. The model data may be distinct from and independent of the tool-specific functionality data. The processor(s) may execute the instructions to perform a software tool risk assessment based on the model data and independent from the tool-specific functionality data. The processor(s) may execute the instructions to generate a model-based risk determination based on the software tool risk assessment. The processor(s) may execute the instructions to output the model-based risk determination via the tool assessment interface.

Another aspect of the present disclosure relates to a method for performing an information technology security risk assessment. The method may include providing a tool assessment interface for receiving model data associated with a software tool. The software tool may be characterized by the model data and by tool-specific functionality data. The method may include obtaining the model data for the software tool. The model data may be distinct from and independent of the tool-specific functionality data. The method may include performing a software tool risk assessment based on the model data and independent from the tool-specific functionality data. The method may include generating a model-based risk determination based on the software tool risk assessment. The method may include outputting the model-based risk determination via the tool assessment interface.

Yet another aspect of the present disclosure relates to a non-transient computer-readable storage medium having instructions embodied thereon, the instructions being executable by one or more processors to perform a method for performing an information technology security risk assessment. The method may include providing a tool assessment interface for receiving model data associated with a software tool. The software tool may be characterized by the model data and by tool-specific functionality data. The method may include obtaining the model data for the software tool. The model data may be distinct from and independent of the tool-specific functionality data. The method may include performing a software tool risk assessment based on the model data and independent from the tool-specific functionality data. The method may include generating a model-based risk determination based on the software tool risk assessment. The method may include outputting the model-based risk determination via the tool assessment interface.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

A tool assessment interface may comprise any type of visual, graphical or textual interface configured to receive data in order to perform an assessment of a software tool. In an example embodiment, the tool assessment interface comprises an online form, such as a web-based form, for example an HTML (hypertext markup language) form or a form in an app or other platform. In another example embodiment, the tool assessment interface comprises and/or is implemented within or as part of a chatbot or other interactive communication or messaging means or platform. In another example embodiment, the tool assessment interface comprises a document, for example an online document or document permitting collaboration, or an offline document such as a word processing file or spreadsheet.

A software tool as referred to herein may be any software tool configured to perform functions, for example IT security functions. The software tool may be provided by a vendor for use by an organization and in relation to the organization's IT systems.

The software tool may be characterized by model data, which comprises data characterizing a model according to which the software was built. The model data does not identify the specific functionality of the tool, in terms of exactly how it performs the functions, but rather refers to design approaches and parameters. In an embodiment, the model data comprises high level functionality data, for example associated with the type of functionality provided, without providing low level details associated with how the functionality is working.

The software tool may also be characterized by tool-specific functionality data, which characterize the functionality in more detail, and may describe the tool in such a way that the nature and functionality of the tool, and how the tool performs the functionality, is derivable therefrom. In an example implementation, the model data may be defined such that it is distinct from and independent of the tool-specific functionality data. As described above, in an embodiment, the tool-specific functionality data comprises low level details associated with how the functionality is working, while the model data may comprise high level functionality data.

Model risk governance may require that economic and fraud models of an AI/ML nature go through the model risk policy governance. They may be inventoried with a name and number. According to embodiments of the present disclosure, the cyber tooling that an organization uses to protect itself, which is vendor built, is being used in a new way and in an application for which it was not originally intended.

Model risk management is typically about making sure there is no bias. A model validation team and model risk management are model professionals, and not cyber professionals. Embodiments of the present disclosure are configured to provide an interface such that the interface enables cyber professionals to answer questions without being model professionals. Using embodiments of the present disclosure, an organization can approach a software tool vendor in a situation where there's a “black box” with the software tool's AI and capabilities. As per contracts, the organization will not ask the vendor about the secret, the vendor just provides the service. For example, a software tool such as Shape Security provides bot protection, which sees something trending and identifies whether it's a bot attack, as opposed to automated scripting public data, to distinguish between both attacks.

There are regulatory drivers to performing risk assessment for cyber tools. For example, for an organization that may employ over 40 software tools, about a quarter may be identified as having AI/ML/statistical models. Organizations may make efforts to work with those vendors to understand as much as they can about a tool that they can't talk to the vendors about in detail. Embodiments of the present disclosure can assist in such a scenario.

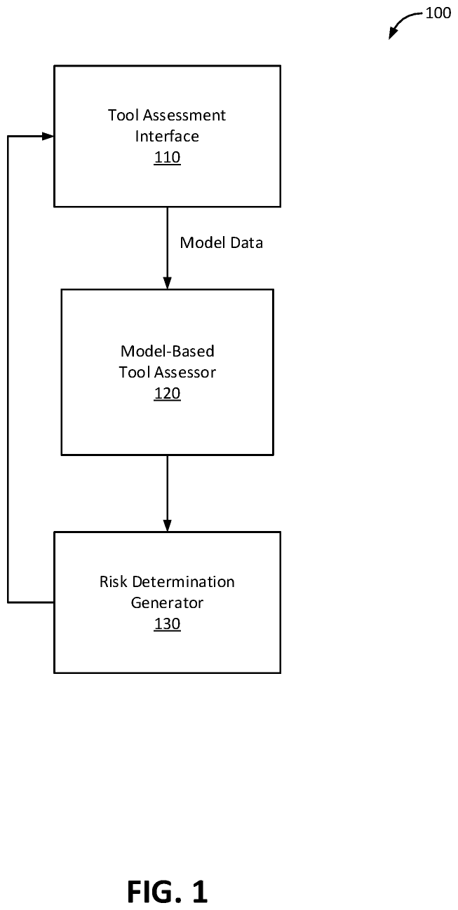

FIG. 1 illustrates a system 100 configured for performing an information technology security risk assessment, in accordance with one or more embodiments. The risk assessment may be with respect to an impact that adopting a certain software tool may have on the security of an information technology environment. For example, the risk assessment may assess the IT security risk involved with implementing a software tool for detecting and blocking malicious activity.

In an embodiment, the system 100 comprises a computing platform configured for performing an information technology security risk assessment. The computing platform may include a non-transient computer-readable storage medium having executable instructions embodied thereon. The computing platform may include one or more hardware processors configured to execute the instructions.

The processor(s) may execute the instructions to provide a tool assessment interface 100 for receiving model data associated with a software tool. The software tool may be characterized by the model data and by tool-specific functionality data. The processor(s) may execute the instructions to obtain the model data for the software tool. The model data may be distinct from and independent of the tool-specific functionality data. The processor(s) may execute the instructions to perform, at a model-based tool assessor 120, a software tool risk assessment based on the model data and independent from the tool-specific functionality data.

In an example embodiment, the model-based tool assessor may be configured to perform the software tool risk assessment based on the model data, where the model data includes a model type identifier. For example, the system may associate a lower risk with one type of model, and a higher risk with another type of model. The system may perform the software tool risk assessment based, at least in part, on a model type identifier included with the model data, and based on a stored risk level or risk profile associated with the model type identifier. In an implementation, the system may assign one of a plurality of fixed model risk levels or scores to a software tool being assessed based on the model data and on a model type derivable from the model data.

For example, if the received model data indicates that the model is associated with a higher level of risk, the system may configure the interface to prompt for additional information, based on the risk level associated with the model type, or the identified model. For example, if a software tool has model data that identifies the software tool as relating to malware, the system may configure the interface to prompt for and obtain additional information based on a higher risk profile associated with software tools having a malware model type.

The processor(s) may execute the instructions to generate, at a risk determination generator 130, a model-based risk determination based on the software tool risk assessment. The processor(s) may execute the instructions to output the model-based risk determination via the tool assessment interface 110. In contrast to known approaches in which a system may make a risk determination based on known functionality of a software tool, embodiments of the present disclosure perform and output a model-based risk determination, in which the risk determination is based on model data, rather than tool-specific functionality data. As outlined above, this is particularly beneficial when the tool-specific functionality data is unavailable, for example because it is confidential and/or is part of an AI- or ML-based solution for which such tool-specific functionality data may not be provided.

In an implementation, the tool assessment interface 110 is configured to ask detailed questions about the model behind the tool, to help an organization with risk management, in situations where vendors will not or cannot provide the organization with proprietary or confidential details about the operation of the tool, which you would normally do with other tools.

The system may improve functioning of a processor executing or associated with execution of the system access channel, by making the processor more efficient. For example, the authentication hub may impart an authentication function on the system access channel without the system access channel having the function, reducing the processor load and cost, as well as reducing the memory required. Such improvements and solutions to computer problems are also achieved by methods of one or more embodiments described and illustrated herein.

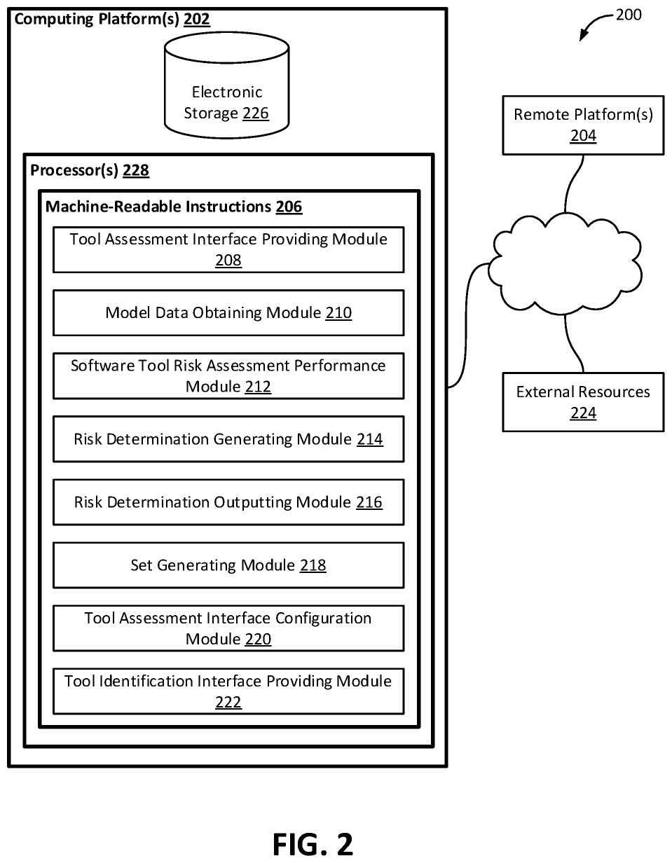

FIG. 2 illustrates a system 200 configured for performing an information technology security risk assessment, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of tool assessment interface providing module 208, model data obtaining module 210, software tool risk assessment performance module 212, risk determination generating module 214, risk determination outputting module 216, set generating module 218, tool assessment interface configuration module 220, tool identification interface providing module 222, and/or other instruction modules.

Tool assessment interface providing module 208 may be configured to provide a tool assessment interface for receiving model data associated with a software tool. The software tool may be characterized by the model data and by tool-specific functionality data.

Model data obtaining module 210 may be configured to obtain the model data for the software tool. The model data may be distinct from and independent of the tool-specific functionality data.

Software tool risk assessment performance module 212 may be configured to perform a software tool risk assessment based on the model data and independent from the tool-specific functionality data.

Software tool risk assessment performance module 212 may be configured to perform the software tool risk assessment based on the generated first set of model data and the vendor-provided second set of model data.

Risk determination generating module 214 may be configured to generate a model-based risk determination based on the software tool risk assessment.

Risk determination outputting module 216 may be configured to output the model-based risk determination via the tool assessment interface.

Set generating module 218 may be configured to generate a first set of model data for pre-population in the tool assessment interface prior to provision of the tool assessment interface to a vendor associated with the software tool.

Set generating module 218 may be configured to generate at least a portion of the first set of model data based on a tool type indicator associated with the software tool. In an example embodiment, the tool type indicator may be a stored indication of a type of software tool, for example: abnormal traffic detection and/or prevention; malicious activity detection and/or blocking; behavior anomalies detection; risk assessment. Specific examples of tool type indicators may include bot protection and firewall, though these may alternatively be represented or indicated by a broader category such as abnormal traffic detection/prevention or malicious activity detection/blocking.

The tool type indicator may be derived or determined based on an identification of the software tool, which may be provided by the vendor, or may be based on comparing a provided tool type indicator with stored records. For example, a vendor may provide, via an interface, a tool type indicator; alternatively, the vendor may provide a product name associated with the software tool, and the system may be in communication with a software tool database and may determine the tool type indicator based on the software tool database and on the provided product name.

In an example implementation, a tool type indicator may be used to pre-populate or pre-fill data in the interface based on prior knowledge of answers given for a particular tool type. For example, based on a review of answers or details provided with respect to malware software tools, the system may identify and compile a set of answers, such as a portion of the first set of model data, and associate that set of answers with a tool type indicator associated with malware tools. Subsequently, when a software tool is associated with a tool type indicator of “malware”, the system may obtain and pre-populate in the interface a portion of the first set of model data. In an embodiment, set generating module 218 is provided in a computing platform 202 associated with the organization performing the risk assessment. In another embodiment, a module similar to set generating module 218 may be provided at, or in communication with, a computing platform associated with the vendor of the software tool being assessed, so that the pre-population of data based on the tool type indicator may optionally be performed or enabled on the vendor side.

Tool assessment interface configuration module 220 may be configured to configure the tool assessment interface to present the first set of model data and to present a plurality of interface elements configured to receive a second set of vendor-provided model data. The model data may include anonymized model data such that the tool-specific functionality data is undiscoverable based on the anonymized model data. The tool assessment interface configuration module 220 may be configured to configure the tool assessment interface to present an anonymized interface, for example an anonymized document. In an implementation, the anonymized document protects the vendor's proprietary content, while providing the organization with the information they need to make a model risk assessment. In an implementation, the organization may partially complete and/or pre-populate the model risk management process and provide the vendor with an interface in which missing data is to be completed. The organization provides questions to the vendor, and the information that the organization needs.

The software tool being evaluated has model characteristics, or model data, and cyber characteristics, or functionality data. In an implementation, the anonymized document pre-completes many of the model characteristics and asks for missing model information as well as missing cyber information, without the person completing it having to enter (or know about) any of the model characteristics or details. This saves time for the vendor and for the organization, and also assists in better regulatory compliance.

In an embodiment, the interface may be based on a model development report (MD) that may submitted. Using a system or method according to one or more embodiments, organizations are able to successfully validate a software tool with respect to IT security risk, without compromising vendor data or organizational data or resources.

Tool identification interface providing module 222 may be configured to provide a tool identification interface for receiving the tool type indicator, prior to providing the tool assessment interface.

In some embodiments, computing platform(s) 202, remote platform(s) 204, and/or external resources 224 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 224 may be operatively linked via some other communication media.

A given remote platform 204 may include one or more processors configured to execute computer program modules. The computer program modules may be configured to enable an expert or user associated with the given remote platform 204 to interface with system 200 and/or external resources 224, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 224 may include sources of information outside of system 200, external entities participating with system 200, and/or other resources. In some embodiments, some or all of the functionality attributed herein to external resources 224 may be provided by resources included in system 200.

Computing platform(s) 202 may include electronic storage 226, one or more processors 228, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 226 may comprise non-transitory storage media that electronically stores information. The electronic storage media of electronic storage 226 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 226 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 226 may include one or more virtual storage resources (e.g., cloud storage, a virtual private network, and/or other virtual storage resources). Electronic storage 226 may store software algorithms, information determined by processor(s) 228, information received from computing platform(s) 202, information received from remote platform(s) 204, and/or other information that enables computing platform(s) 202 to function as described herein.

Processor(s) 228 may be configured to provide information processing capabilities in computing platform(s) 202. As such, processor(s) 228 may include one or more of a digital processor, an analog processor, a digital circuit designed to process information, an analog circuit designed to process information, a state machine, and/or other mechanisms for electronically processing information. Although processor(s) 228 is shown in FIG. 2 as a single entity, this is for illustrative purposes only. In some embodiments, processor(s) 228 may include a plurality of processing units. These processing units may be physically located within the same device, or processor(s) 228 may represent processing functionality of a plurality of devices operating in coordination. Processor(s) 228 may be configured to execute modules 208, 210, 212, 214, 216, 218, 220, and/or 222, and/or other modules. Processor(s) 228 may be configured to execute modules 208, 210, 212, 214, 216, 218, 220, and/or 222, and/or other modules by software; hardware; firmware; some combination of software, hardware, and/or firmware; and/or other mechanisms for configuring processing capabilities on processor(s) 228. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, and/or 222 are illustrated in FIG. 2 as being implemented within a single processing unit, in embodiments in which processor(s) 228 includes multiple processing units, one or more of modules 208, 210, 212, 214, 216, 218, 220, and/or 222 may be implemented remotely from the other modules. The description of the functionality provided by the different modules 208, 210, 212, 214, 216, 218, 220, and/or 222 described below is for illustrative purposes, and is not intended to be limiting, as any of modules 208, 210, 212, 214, 216, 218, 220, and/or 222 may provide more or less functionality than is described. For example, one or more of modules 208, 210, 212, 214, 216, 218, 220, and/or 222 may be eliminated, and some or all of its functionality may be provided by other ones of modules 208, 210, 212, 214, 216, 218, 220, and/or 222. As another example, processor(s) 228 may be configured to execute one or more additional modules that may perform some or all of the functionality attributed below to one of modules 208, 210, 212, 214, 216, 218, 220, and/or 222.

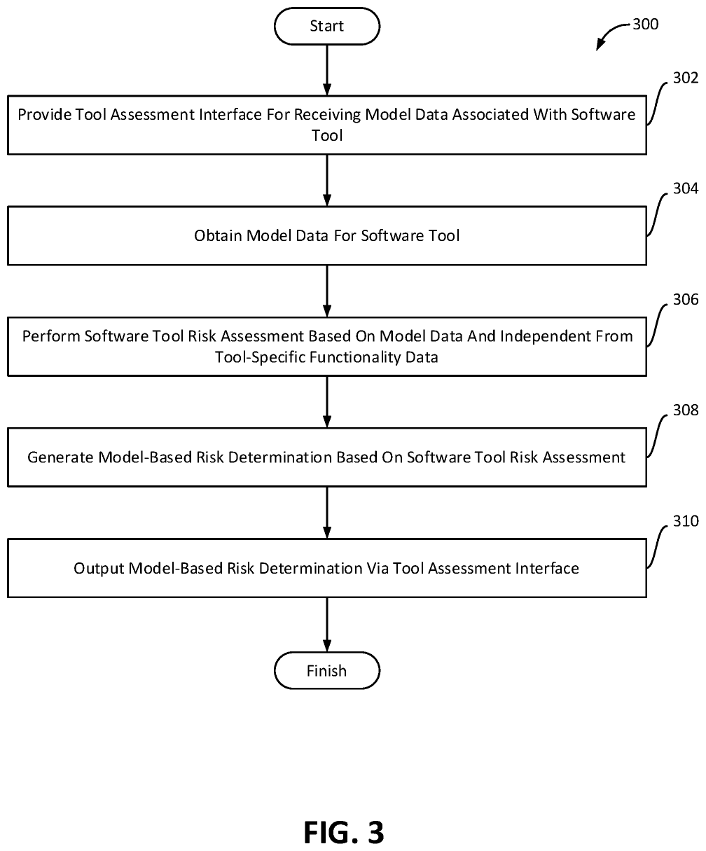

FIG. 3 illustrates a method 300 for performing an information technology security risk assessment, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include providing a tool assessment interface for receiving model data associated with a software tool. The software tool may be characterized by the model data and by tool-specific functionality data. Operation 302 may be performed by one or more hardware processors configured by machine-readable instructions including a module that is the same as or similar to tool assessment interface providing module 208, in accordance with one or more embodiments.

An operation 304 may include obtaining the model data for the software tool. The model data may be distinct from and independent of the tool-specific functionality data. Operation 304 may be performed by one or more hardware processors configured by machine-readable instructions including a module that is the same as or similar to model data obtaining module 210, in accordance with one or more embodiments.

An operation 306 may include performing a software tool risk assessment based on the model data and independent from the tool-specific functionality data. Operation 306 may be performed by one or more hardware processors configured by machine-readable instructions including a module that is the same as or similar to software tool risk assessment performance module 212, in accordance with one or more embodiments.

An operation 308 may include generating a model-based risk determination based on the software tool risk assessment. Operation 308 may be performed by one or more hardware processors configured by machine-readable instructions including a module that is the same as or similar to risk determination generating module 214, in accordance with one or more embodiments.

An operation 310 may include outputting the model-based risk determination via the tool assessment interface. Operation 310 may be performed by one or more hardware processors configured by machine-readable instructions including a module that is the same as or similar to risk determination outputting module 216, in accordance with one or more embodiments.

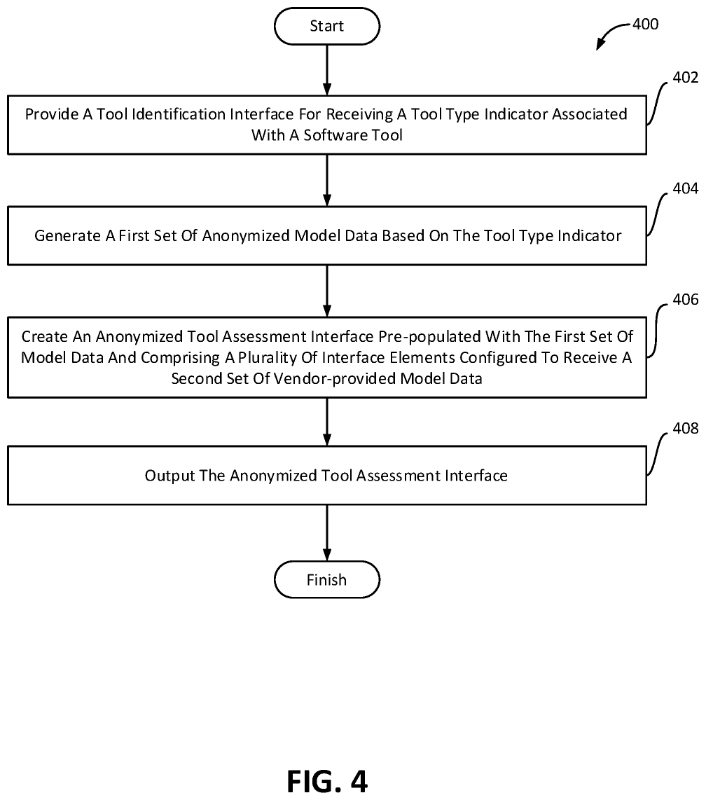

FIG. 4 illustrates a method 400 of initiating an information technology security risk assessment, in accordance with one or more embodiments. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include providing a tool identification interface for receiving a tool type indicator associated with a software too. The software tool may be characterized by model data and by tool-specific functionality data. Operation 402 may be performed by one or more hardware processors configured by machine-readable instructions including a module that is similar to tool assessment interface providing module 208 of FIG. 2, but may be implemented as a tool identification interface providing module, in accordance with one or more embodiments.

An operation 404 may include generating a first set of anonymized model data based on the tool type indicator. The first set of model data may be a subset of the model data characterizing the software tool. The tool-specific functionality data may be undiscoverable based on the first set of anonymized model data. Operation 404 may be performed by one or more hardware processors configured by machine-readable instructions including a module such as an anonymized model data generating module, in accordance with one or more embodiments.

An operation 406 may include creating an anonymized tool assessment interface pre-populated with the first set of model data. The tool assessment interface may further comprise a plurality of interface elements configured to receive a second set of vendor-provided model data. The tool-specific functionality data may be undiscoverable based on the received second set of vendor-provided model data. Operation 406 may be performed by one or more hardware processors configured by machine-readable instructions including a module that is the same as or similar to tool assessment interface providing module 208 of FIG. 2, in accordance with one or more embodiments, and may be implemented as an anonymized tool assessment interface providing module.

An operation 408 may include outputting the anonymized tool assessment interface. Operation 408 may be performed by one or more hardware processors configured by machine-readable instructions including a module that is the same as or similar to tool assessment interface providing module 208 of FIG. 2, in accordance with one or more embodiments, and may be implemented as an anonymized tool assessment interface providing module.

With respect to the method of FIG. 4, a further set of operations (not shown) may comprise: receiving the second set of vendor-provided model data; performing a software tool risk assessment based on based on the first set of anonymized model data the received second set of vendor-provided model data; generating a model-based risk determination based on the software tool risk assessment; and outputting the model-based risk determination via the tool assessment interface. This set of operations may be performed by one or more hardware processors configured by machine-readable instructions including a module that is the same as or similar to tool assessment interface providing module 208 of FIG. 2, along with one or more other modules, in accordance with one or more embodiments, and may be implemented as an anonymized tool assessment interface providing module.

In an example implementation, the vendor or the organization may complete an initial model risk assessment, for example asking is there AI/ML involved in the software tool being assessed. In an example implementation, the organization knows what the tool does, but does not know the detail of the “magic”. Some capabilities in terms of the “magic” of such tools include: security event monitoring, firewall, bot protection, data loss prevention. Some are logical capabilities, some are on-premise, etc. It can be very difficult for companies to understand that they need help, and sometimes reluctant to share information

After a model risk team has looked at a tool, the organization may implement an interface according to one or more embodiments for receiving model data and/or functionality data. In an implementation, the interface comprises a Model Development Report (MDR). According to one approach, the interface may be produced based on data or feedback received from subject-matter experts (SMEs) and a model developer. Embodiments of the present disclosure provide a novel approach of analyzing an underlying model to perform an IT security risk assessment, where the model is used to make decisions relating to the tool, without having details about the functionality of the tool.

In an example implementation, an organization may create an anonymized interface or document so that the sections are 70-80% completed, but in an anonymous way so that neither the vendor nor the organization can determine what kind of software tool it is, and what kind of protection it provides to the organization. Embodiments of the present disclosure may provide a vendor with 70-80% of their “homework” and ask them to complete it, for the benefit of the organization and their risk assessment. The interface may obtain data associated with the vendor's assessment of how the vendor keeps their model compliant at all times, including providing data relating to ongoing metrics.

In an implementation, an organization creates an anonymized interface or document with cyber tooling, which increases vendor engagement and facilitates evaluation of software tools. In one implementation, the interface may be provided as a word processing document for a vendor to complete. In another implementation, the interface may be provided as a web-based form, or in some other interactive user interface. The document/interface is provided such that it reflects and obtains data relating to the process used to define and run the models, rather than the secret sauce behind the models. An organization may then understand the process and how they can manage everything, without requiring all of the underlying functionality details.

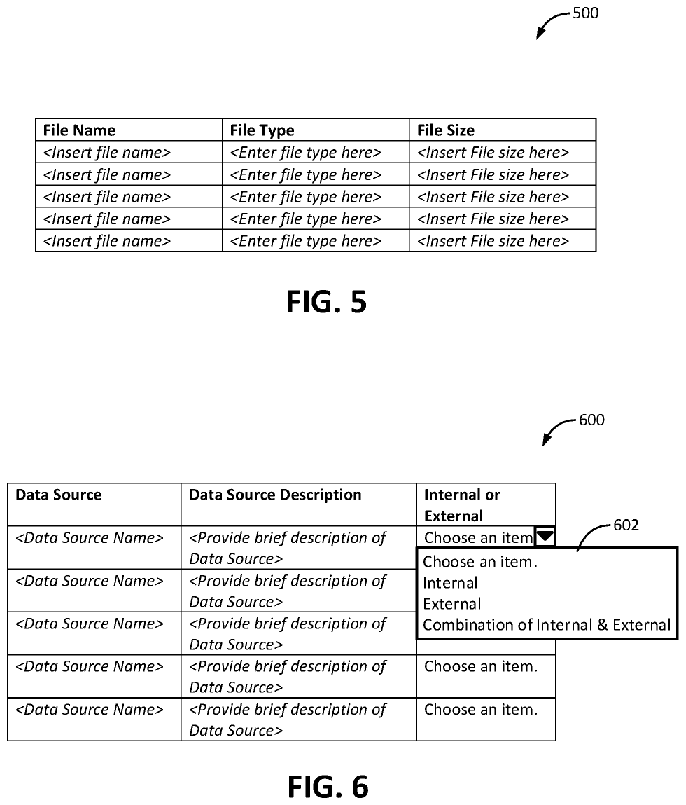

FIGS. 5-10 illustrate examples of an interface generated in accordance with one or more embodiments as part of an information technology security risk assessment. The interfaces shown in FIGS. 5-10 relate to an example illustrating interface elements that may be provided as part of a tool assessment interface or a tool identification interface, in particular with respect to model development data in the case of FIG. 5 and FIG. 6. The interface elements are configured to prompt for or obtain model data relating to the data used by a vendor and a level of transparency/accessibility to the organization, e.g. for review/verification or internal model development, and may also apply to internal data provided by the organization for the vendor's model training.

FIG. 5 illustrates an interface 500 including a plurality of fields, including File Name, File Type and File Size. If the data is sourced solely by the organization hosting or running the software tool, a description of how the data is provided is entered. In an example embodiment, the interface comprises form fields or other input means for receiving text entry for each of the File Name, File Type and File Size fields for each instance. The interface 500 may also comprise additional means to prompt for or obtain additional references or attachments that the vendor may wish to provide.

FIG. 6 illustrates an interface 600 including a plurality of fields relating to data sources that may be used or provided for model development, for example if such data is not sourced solely from the organization. The fields Data Source and Data Source Description may be provided as form fields, or an equivalent means, for entry of the relevant data in a free-form text field. As described earlier, the tool assessment interface 600 may comprises a question and an interactive interface element, the interactive interface element providing a fixed set of options from which an answer to the question is to be selected, such as a drop-down list, or a pop-up menu.

In FIG. 6, with respect to the column indicating Internal or External, the interface 600 may comprise a drop-down menu 602 configured to provide the limited options of: Internal; External; or Combination of Internal & External. By providing an interactive element with a fixed set of options, the interface 600 provides an improved means to obtain model data characterizing the software tool, such that the vendor is not required to divulge sensitive data, while the organization is able to obtain sufficient data to perform the IT security risk assessment. Furthermore, an interface element with a fixed set of options provides a basis for pre-populating certain aspects of an interface, for example based on a tool type indicator and/or based on stored data in a software tool model data database.

The interface 600 may additionally include an interface element configured to obtain data related to whether each customer providing data will have access to their submission. The interface 600 may also comprise additional means to prompt for or obtain additional references or attachments that the vendor may wish to provide.

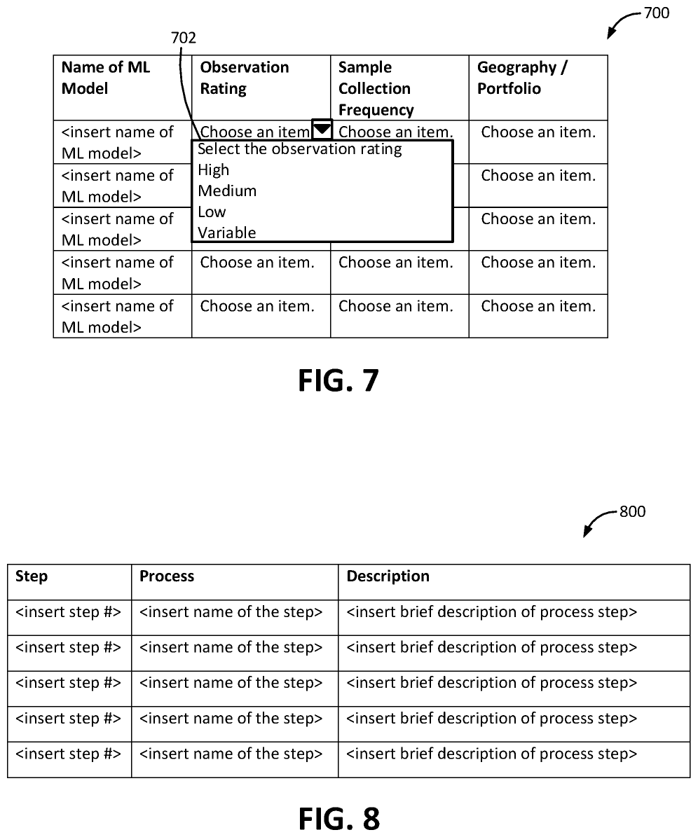

FIG. 7 illustrates an interface 700 including a plurality of fields relating to data sources that may be used or provided for training data composition, sources and proxies, in accordance with one or more embodiments. For each of the ML models in the vendor tool/system, the interface 700 may be configured to obtain: a description of the data splitting strategy (train/validation/test, cross-validation/test, or otherwise); information about the sampling process, such as whether sampling is stratified and, if so, across which dimensions; and metadata of the development data, including approximate number of observations used to train the individual ML models, time periods, geography/portfolios, etc., information about the sampling process, whether sampling is stratified and, if so, across which dimensions.

The interface 700 may be configured to obtain a brief explanation of a sampling process/strategy used in relation to the software tool. In the example interface 700 in FIG. 7, other than the name of the ML model, which is a free-form text box, the remaining interface elements comprise interactive elements, such as drop-down menus. For example, with respect to the Observation Rating, a drop-down menu 702 is provided, according to which data may be obtained with respect to whether the observation rating is: high; medium; low; or variable. In an example embodiment, “high” may correspond to greater than 10,000 observations, “medium” may correspond to between 1,000 and 9,999 observations, and “low” may correspond to fewer than 1,000 observations. If the collection frequency is variable, a further interface element may be provided for additional information regarding the collection frequency may be entered.

Similarly, the interface 700 comprises a drop-down menu for Sample Collection Frequency, where the data may be selected from: weekly; monthly; annual; or variable. Additionally, the interface 700 comprises a drop-down menu for Geography/Portfolio, where the data may be selected from, for example: USA; Canada; International; USA/Canada; USA/International; Canada/International; USA/Canada/International. If the sourced data is not split for training, the interface 700 may comprise an interface element configured to obtain a brief explanation why data is not required to be split and how model training is performed. The interface 700 may also comprise additional means to prompt for or obtain additional references or attachments that the vendor may wish to provide.

FIGS. 8-10 illustrate interfaces 800, 900 and 1000 including a plurality of fields relating to model training data. In an example embodiment, the interfaces obtain data relating to the model training dataset construction with sufficient detail to allow a third party to replicate the dataset from source systems and assess the data process/quality. In an example embodiment, a vendor may provide a process map and description of all data sources and inputs to model. Details may be provided on the frequency of data update/refresh, data controls (e.g. management approvals or reviews) and/or system limitations. For each of the ML models in the vendor tool/system, the interface may be configured to obtain data relating to the model training dataset descriptions, and evidence of adequate checks for data quality, data representativeness to the organization's use-case, and data completeness.

FIG. 8 illustrates an interface 800 in which a description of the model training data process and the steps involved, in the case where a process map of all the data sources is not obtained or provided, in accordance with one or more embodiments. The interface 800 includes a plurality of fields, including Step, Process and Description, in which a step number, name of the step, and brief description of the process step may be entered/obtained. In an example embodiment, the interface comprises form fields or other input means for receiving text entry for each of the Step, Process and Description fields for each instance. The interface 800 may also comprise additional means to prompt for or obtain additional references or attachments that the vendor may wish to provide.

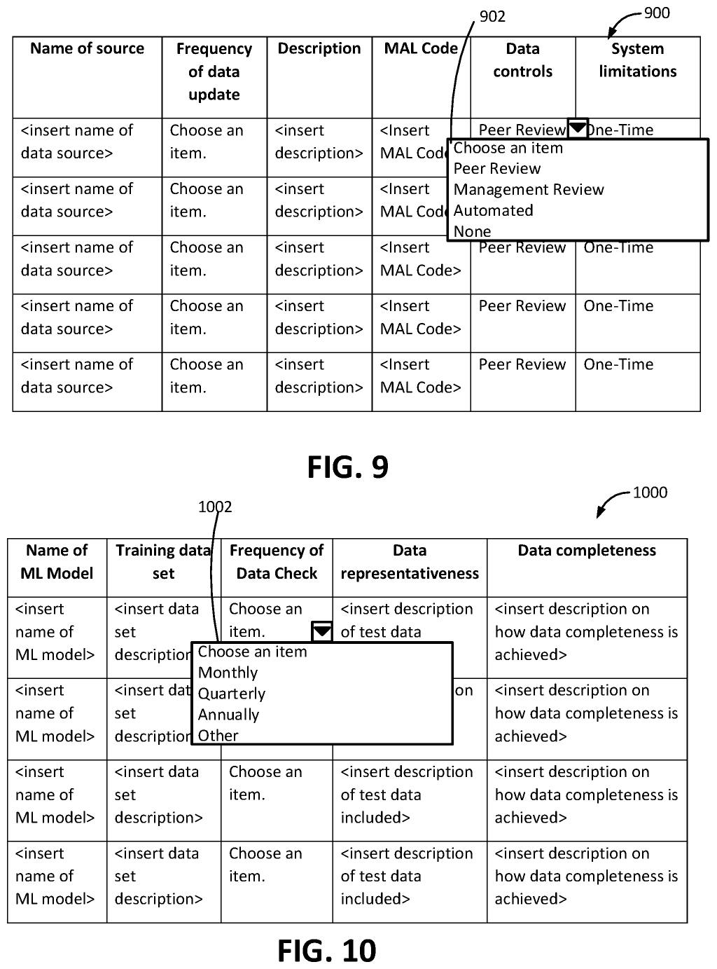

FIG. 9 illustrates an interface 900 configured to obtain/prompt for details relating to the model training data process identified via the interface 800 in FIG. 8, in accordance with one or more embodiments. In the example interface 900, other than the Name of Source, Description, and MAL (Macro Assembly Language) Code, which are free-form text boxes, the remaining interface elements comprise interactive elements, such as drop-down menus. For example, with respect to Data Controls, a drop-down menu 902 is provided, according to which data may be obtained with respect to whether the data controls are: peer review; management review; automated; or none.

Similarly, the interface 900 comprises a drop-down menu for Frequency of Data Update, where the data may be selected from: hourly (e.g. less than 2 hours); daily (e.g. between about 12-24 hours); weekly (e.g. less than 8 days); monthly (e.g. 30 days); quarterly (e.g. between 30-90 days); and other (frequency varies). Additionally, the interface 700 comprises a drop-down menu for System Limitations, where the data may be selected from, for example: time-based; system generated; one-time; or daily query. The interface 900 may also comprise additional means to prompt for or obtain additional references or attachments that the vendor may wish to provide.

FIG. 10 illustrates an interface 1000 configured to obtain/prompt for details for each model relating to the model training data process identified via the interface 800 in FIG. 8 and via the interface 900 in FIG. 9, in accordance with one or more embodiments. The details in relation to the interface 1000 in FIG. 10 relate to specific models, whereas the details in relation to FIG. 8 relate to the model training process and steps, and details in relation to FIG. 9 relate to details of each source.

In the interface 1000, most of the fields including Name of ML Model, Training Data Set, Data Representativeness and Data Completeness are free-form text boxes. The Frequency of Data Check interface element comprises an interactive element, such as a drop-down menu. For example, a drop-down menu 1002 is provided for Frequency of Data Check, where the data may be selected from: monthly (e.g. less than 30 days); quarterly (e.g. between 30-90 days); annually (e.g. greater than 90 days); and other (frequency varies). The interface 1000 may also comprise additional means to prompt for or obtain additional references or attachments that the vendor may wish to provide.

The present disclosure provides an anonymized model risk management process to perform, or assist in performing, IT security risk management. A process in accordance with one or more embodiments analyzes data associated with a model behind a tool, to help with risk management for the tool itself. In the absence of being able to ask a vendor for specific details on how AI or ML works within a software tool, embodiments of the present disclosure provide a means to perform a software tool risk assessment without needing that information that the vendor may not be in a position to disclose, and may advantageously provide an interface that is pre-populated with a first set of model data, while requesting a second set of vendor-provided model data.

Embodiments of the present disclosure provide a system or method for performing an information technology security risk assessment, for example with respect to a software tool provided by a vendor to an organization. Implementing embodiments of the present disclosure provides a reduction in time and investment on software tool assessments, by automating the provision of an interface for a vendor to complete a form related to the assessment, and optionally by pre-populating some of the form based on an identification of a type of tool and/or based on other model data, and associated risk profiles. Without embodiments of the present disclosure, organizations and vendors spend inordinate amounts of time manually completing risk assessment documentation. Even then, when software tools use AI or ML and the vendor does not want to disclose functionality details to the organization, this can prevent the ability to perform a software risk assessment.

Embodiments of the present disclosure use model data to perform a software risk assessment, rather than a model assessment, thereby using the model data for a purpose for which it was not originally intended, and providing an improvement in the functionality of processors involved in the risk assessment process. Using embodiments of the present disclosure, a tool assessment interface is generated and output, such that these steps result in a change in the memory and in the data stored in the memory associated with the processor generating and displaying or outputting the interface, as well as having a discernible effect or change on both the stored data in the memory, and the data output for display. These improvements help to reduces the cost associated with the risk assessment process, and enable an organization to perform a risk assessment on a software tool when all of the typical functionality data is not available. Risk assessments in situations like this are not possible using known approaches, and embodiments of the present disclosure provide an improvement by enabling such risk assessments to be performed based on the model data, and without any of the low-level functionality data relating to how the software tool performs functions that may be implemented using AI or ML.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for performing an information technology security risk assessment. The system may include one or more hardware processors configured by machine-readable instructions. The processor(s) may be configured to provide a tool assessment interface for receiving model data associated with a software tool. The software tool may be characterized by the model data and by tool-specific functionality data. The processor(s) may be configured to obtain the model data for the software tool. The model data may be distinct from and independent of the tool-specific functionality data. The processor(s) may be configured to perform a software tool risk assessment based on the model data and independent from the tool-specific functionality data. The processor(s) may be configured to generate a model-based risk determination based on the software tool risk assessment. The processor(s) may be configured to output the model-based risk determination via the tool assessment interface.

In some implementations of the system, the processor(s) may be configured to generate a first set of model data for pre-population in the tool assessment interface prior to provision of the tool assessment interface to a vendor associated with the software tool. In some implementations of the system, the processor(s) may be configured to configure the tool assessment interface to present the first set of model data and to present a plurality of interface elements configured to receive a second set of vendor-provided model data. In some implementations of the system, the processor(s) may be configured to perform the software tool risk assessment based on the generated first set of model data and the vendor-provided second set of model data.

In some implementations of the system, the processor(s) may be configured to generate at least a portion of the first set of model data based on a tool type indicator associated with the software tool.

In some implementations of the system, the processor(s) may be configured to provide a tool identification interface for receiving the tool type indicator, prior to providing the tool assessment interface.

In some implementations of the system, the model data may include anonymized model data such that the tool-specific functionality data is undiscoverable based on the anonymized model data.

Another aspect of the present disclosure relates to a method for performing an information technology security risk assessment. The method may include providing a tool assessment interface for receiving model data associated with a software tool. The software tool may be characterized by the model data and by tool-specific functionality data. The method may include obtaining the model data for the software tool. The model data may be distinct from and independent of the tool-specific functionality data. The method may include performing a software tool risk assessment based on the model data and independent from the tool-specific functionality data. The method may include generating a model-based risk determination based on the software tool risk assessment. The method may include outputting the model-based risk determination via the tool assessment interface.

In some implementations of the method, it may include generating a first set of model data for pre-population in the tool assessment interface prior to provision of the tool assessment interface to a vendor associated with the software tool. In some implementations of the method, it may include configuring the tool assessment interface to present the first set of model data and to present a plurality of interface elements configured to receive a second set of vendor-provided model data. In some implementations of the method, it may include performing the software tool risk assessment based on the generated first set of model data and the vendor-provided second set of model data.

In some implementations of the method, it may include generating at least a portion of the first set of model data based on a tool type indicator associated with the software tool.

In some implementations of the method, it may include providing a tool identification interface for receiving the tool type indicator, prior to providing the tool assessment interface.

In some implementations of the method, the model data may include anonymized model data such that the tool-specific functionality data is undiscoverable based on the anonymized model data.

Yet another aspect of the present disclosure relates to a non-transient computer-readable storage medium having instructions embodied thereon, the instructions being executable by one or more processors to perform a method for performing an information technology security risk assessment. The method may include providing a tool assessment interface for receiving model data associated with a software tool. The software tool may be characterized by the model data and by tool-specific functionality data. The method may include obtaining the model data for the software tool. The model data may be distinct from and independent of the tool-specific functionality data. The method may include performing a software tool risk assessment based on the model data and independent from the tool-specific functionality data. The method may include generating a model-based risk determination based on the software tool risk assessment. The method may include outputting the model-based risk determination via the tool assessment interface.

In some implementations of the computer-readable storage medium, the method may include generating a first set of model data for pre-population in the tool assessment interface prior to provision of the tool assessment interface to a vendor associated with the software tool. In some implementations of the computer-readable storage medium, the method may include configuring the tool assessment interface to present the first set of model data and to present a plurality of interface elements configured to receive a second set of vendor-provided model data. In some implementations of the computer-readable storage medium, the method may include performing the software tool risk assessment based on the generated first set of model data and the vendor-provided second set of model data.

In some implementations of the computer-readable storage medium, the method may include generating at least a portion of the first set of model data based on a tool type indicator associated with the software tool.

In some implementations of the computer-readable storage medium, the method may include providing a tool identification interface for receiving the tool type indicator, prior to providing the tool assessment interface.

In some implementations of the computer-readable storage medium, the model data may include anonymized model data such that the tool-specific functionality data is undiscoverable based on the anonymized model data.

Still another aspect of the present disclosure relates to a system configured for performing an information technology security risk assessment. The system may include means for providing a tool assessment interface for receiving model data associated with a software tool. The software tool may be characterized by the model data and by tool-specific functionality data. The system may include means for obtaining the model data for the software tool. The model data may be distinct from and independent of the tool-specific functionality data. The system may include means for performing a software tool risk assessment based on the model data and independent from the tool-specific functionality data. The system may include means for generating a model-based risk determination based on the software tool risk assessment. The system may include means for outputting the model-based risk determination via the tool assessment interface.

In some implementations of the system, the system may include means for generating a first set of model data for pre-population in the tool assessment interface prior to provision of the tool assessment interface to a vendor associated with the software tool. In some implementations of the system, the system may include means for configuring the tool assessment interface to present the first set of model data and to present a plurality of interface elements configured to receive a second set of vendor-provided model data. In some implementations of the system, the system may include means for performing the software tool risk assessment based on the generated first set of model data and the vendor-provided second set of model data.

In some implementations of the system, the system may include means for generating at least a portion of the first set of model data based on a tool type indicator associated with the software tool.

In some implementations of the system, the system may include means for providing a tool identification interface for receiving the tool type indicator, prior to providing the tool assessment interface.

In some implementations of the system, the model data may include anonymized model data such that the tool-specific functionality data is undiscoverable based on the anonymized model data.

Even another aspect of the present disclosure relates to a computing platform configured for performing an information technology security risk assessment. The computing platform may include a non-transient computer-readable storage medium having executable instructions embodied thereon. The computing platform may include one or more hardware processors configured to execute the instructions. The processor(s) may execute the instructions to provide a tool assessment interface for receiving model data associated with a software tool. The software tool may be characterized by the model data and by tool-specific functionality data. The processor(s) may execute the instructions to obtain the model data for the software tool. The model data may be distinct from and independent of the tool-specific functionality data. The processor(s) may execute the instructions to perform a software tool risk assessment based on the model data and independent from the tool-specific functionality data. The processor(s) may execute the instructions to generate a model-based risk determination based on the software tool risk assessment. The processor(s) may execute the instructions to output the model-based risk determination via the tool assessment interface.

In some implementations of the computing platform, the processor(s) may execute the instructions to generate a first set of model data for pre-population in the tool assessment interface prior to provision of the tool assessment interface to a vendor associated with the software tool. In some implementations of the computing platform, the processor(s) may execute the instructions to configure the tool assessment interface to present the first set of model data and to present a plurality of interface elements configured to receive a second set of vendor-provided model data. In some implementations of the computing platform, the processor(s) may execute the instructions to perform the software tool risk assessment based on the generated first set of model data and the vendor-provided second set of model data.

In some implementations of the computing platform, the processor(s) may execute the instructions to generate at least a portion of the first set of model data based on a tool type indicator associated with the software tool.

In some implementations of the computing platform, the processor(s) may execute the instructions to provide a tool identification interface for receiving the tool type indicator, prior to providing the tool assessment interface.

In some implementations of the computing platform, the model data may include anonymized model data such that the tool-specific functionality data is undiscoverable based on the anonymized model data.

What is claimed is:

1. An apparatus configured for providing multi-channel authentication in a system, the apparatus comprising:
a non-transient computer-readable storage medium having executable instructions embodied thereon; and
one or more hardware processors configured to execute the instructions to:
provide a tool assessment interface for receiving model data associated with a software tool, the software tool being characterized by the model data and by tool-specific functionality data;
obtain the model data for the software tool, the model data being distinct from and independent of the tool-specific functionality data;
perform a software tool risk assessment based on the model data and independent from the tool-specific functionality data;
generate a model-based risk determination based on the software tool risk assessment; and
output the model-based risk determination via the tool assessment interface.

2. The apparatus of claim 1 wherein the one or more hardware processors are further configured to execute the instructions to:
generate a first set of model data for pre-population in the tool assessment interface prior to provision of the tool assessment interface to a vendor associated with the software tool; and
configure the tool assessment interface to present the first set of model data and to present a plurality of interface elements configured to receive a second set of vendor-provided model data; and
perform the software tool risk assessment based on the generated first set of model data and the vendor-provided second set of model data.

3. The apparatus of claim 2 wherein the one or more hardware processors are further configured to execute the instructions to:
generating at least a portion of the first set of model data based on a tool type indicator associated with the software tool.

4. The apparatus of claim 3 wherein the one or more hardware processors are further configured to execute the instructions to:
provide a tool identification interface for receiving the tool type indicator, prior to providing the tool assessment interface.

5. The apparatus of claim 1 wherein the model data comprises anonymized model data such that the tool-specific functionality data is undiscoverable based on the anonymized model data.

6. The apparatus of claim 1 wherein the model data comprises anonymized model data such that the tool-specific functionality data is undiscoverable based on the anonymized model data.

7. The apparatus of claim 1 wherein the one or more hardware processors are further configured to execute the instructions to:
output the model-based risk determination to a display.

8. The apparatus of claim 1 wherein the one or more hardware processors are further configured to execute the instructions to:
provide the tool assessment interface comprises providing a question and an interactive interface element, the interactive interface element providing a fixed set of options from which an answer to the question is to be selected.

9. The apparatus of claim 1 wherein the interactive interface element is selected from the group consisting of: a model development data interface element; a data source interface element; a training data composition interface element; a training data sampling interface element; and a model training data interface element.

10. A method for performing an information technology security risk assessment, comprising:
providing a tool assessment interface for receiving model data associated with a software tool, the software tool being characterized by the model data and by tool-specific functionality data;
obtaining the model data for the software tool, the model data being distinct from and independent of the tool-specific functionality data;
performing a software tool risk assessment based on the model data and independent from the tool-specific functionality data;
generating a model-based risk determination based on the software tool risk assessment; and
outputting the model-based risk determination via the tool assessment interface.

11. The method of claim 10 further comprising:
generating a first set of model data for pre-population in the tool assessment interface prior to provision of the tool assessment interface to a vendor associated with the software tool; and
configuring the tool assessment interface to present the first set of model data and to present a plurality of interface elements configured to receive a second set of vendor-provided model data; and
performing the software tool risk assessment based on the generated first set of model data and the vendor-provided second set of model data.

12. The method of claim 11 further comprising:
generating at least a portion of the first set of model data based on a tool type indicator associated with the software tool.

13. The method of claim 12 further comprising:
providing a tool identification interface for receiving the tool type indicator, prior to providing the tool assessment interface.

14. The method of claim 10 wherein the model data comprises anonymized model data such that the tool-specific functionality data is undiscoverable based on the anonymized model data.

15. The method of claim 10 wherein the model data comprises anonymized model data such that the tool-specific functionality data is undiscoverable based on the anonymized model data.

16. The method of claim 10 further comprising:
outputting the model-based risk determination to a display.

17. The method of claim 10 wherein:
providing the tool assessment interface comprises providing a question and an interactive interface element, the interactive interface element providing a fixed set of options from which an answer to the question is to be selected.

18. The method of claim 10 wherein:
the interactive interface element is selected from the group consisting of: a model development data interface element; a data source interface element; a training data composition interface element; a training data sampling interface element; and a model training data interface element.

19. A non-transient computer-readable storage medium having instructions embodied thereon, the instructions being executable by one or more processors to perform a method for providing multi-channel authentication, the method comprising:
providing a tool assessment interface for receiving model data associated with a software tool, the software tool being characterized by the model data and by tool-specific functionality data;
obtaining the model data for the software tool, the model data being distinct from and independent of the tool-specific functionality data;
performing a software tool risk assessment based on the model data and independent from the tool-specific functionality data;
generating a model-based risk determination based on the software tool risk assessment; and
outputting the model-based risk determination via the tool assessment interface.

20. The non-transient computer-readable storage medium of claim 19 wherein the method further comprises:
generating a first set of model data for pre-population in the tool assessment interface prior to provision of the tool assessment interface to a vendor associated with the software tool; and
configuring the tool assessment interface to present the first set of model data and to present a plurality of interface elements configured to receive a second set of vendor-provided model data; and
performing the software tool risk assessment based on the generated first set of model data and the vendor-provided second set of model data.
